(19) United States
(12) Patent Application Publication
(10) Pub. No.: US 2026/0314833 A1
(43) Pub. Date: Oct. 15, 2026

(54) SEAT AND ARMREST BOX AND ASSEMBLY METHOD THEREOF

(71) Applicant: Zhejiang Hengjian Home Furnishing Co., Ltd., Hangzhou (CN)

(72) Inventor: Lujian Wang, Hangzhou (CN)

(21) Appl. No.: 19/178,510

(22) Filed: Apr. 14, 2025

(51) Int. Cl. A47C 7/54; A47C 7/62

(52) U.S. Cl. CPC A47C 7/54; A47C 7/624

(57) ABSTRACT

A seat, an armrest box and an assembly method thereof, comprising panels, side plates, bolts, and nuts; top, front, and rear parts of each panel are each provided with two sets of embedding holes, and the top, front, and rear parts of each panel are each provided with a through hole; left and right ends of each side plate are provided with two sets of snap-fit protrusions; the assembly steps of the armrest box are as follows: step 1: the three side plates are respectively arranged between the tops, between the front parts, and between the rear parts of the two panels, the snap-fit protrusions on the side plates are inserted into the embedding holes on the panels; step 2: bolts are used to connect two panels and tighten them tightly; step 3: an outer cover is used to enclose the panels and side plates, completing the assembly.

### 1. TECHNICAL FIELD

The invention relates to the technical field of home furnishing, in particular to a seat, an armrest box and an assembly method thereof.

### 2. BACKGROUND ART

Before assembling furniture, several pre-fabricated components need to be processed according to the design, and they are then combined together for use. With the diversification and personalization of home or office environments, panel-based modular furniture has become widely popular among consumers. Panel-based modular furniture can be combined in various forms based on changes in the environment. It not only reflects different design styles, but also allows for the maximum utilization of space.

The patent technical document with the publication number CN201031839Y discloses a connecting mechanism for modular furniture, comprising a connecting post and connecting components. Two parallel grooves are arranged on the exterior of any side wall of the connecting post. On one side of the connecting components, two clamping strips that match with the grooves are provided, while the other side is connected to furniture panels. The cross-section of the connecting post is a hollow rectangle, and the cross-sections of the grooves and clamping strips are circular.

In the prior art, it is necessary to ensure a high level of precision between the depth of the groove and the length of the clamping strips, and end faces of the connecting columns and components must be tightly pressed together to ensure the stability of the connection. Additionally, the structure in the prior art requires a tight fit, making it inconvenient for disassembly.

### 3. SUMMARY OF THE INVENTION

In order to solve the problems of high assembly precision requirements and difficulty in disassembly in the prior art, the object of the invention is to provide a seat, an armrest box and an assembly method thereof. The method uses multiple panels to assemble, which facilitates the transportation and replacement of seating components, requires low assembly precision, and ensures high stability of the finished product.

In order to realize the above objects, the invention provides the following technical scheme: an assembly method of an armrest box, comprising panels, side plates, bolts, and nuts; top, front, and rear parts of each panel are each provided with two sets of embedding holes, and the top, front, and rear parts of each panel are each provided with a through hole; left and right ends of each side plate are provided with two sets of snap-fit protrusions. The assembly steps of the armrest box are as follows: step 1: two panels are connected by three side plates, the three side plates are respectively arranged between the tops, between the front parts, and between the rear parts of the two panels, the snap-fit protrusions on the side plates are inserted into the embedding holes on the panels; one side plate is connected only to the top, front, or rear parts of the panels; step 2: a threaded part of each bolt passes through the through holes of the two panels, and then a nut is installed on the bolt, tightening the nut will pull the two panels together, thereby making the two panels clamp the side plates; three bolts are installed on the top, front, and rear parts of the panel, respectively; step 3: an outer cover is used to enclose the panels and side plates, completing the assembly.

Preferably, in the step 1, the three side plates are first installed on one panel, and then the other panel is installed on the three side plates.

Preferably, each embedding hole comprises a first embedding portion, a second embedding portion, and a third embedding portion, each first embedding portion, second embedding portion, and third embedding portion are arranged in a triangular pattern; each snap-fit protrusion on each side plate comprises a first plug-in portion, a second plug-in portion and a third plug-in portion, the first plug-in portions, the second plug-in portions and the third plug-in portions correspond to the first embedding portions, the second embedding portions and the third embedding portions respectively.

Preferably, on each side plate, the first plug-in portions and the second plug-in portions are both arranged on one side surface of the side plate; plug-in rods are fixed on the side plate.

Preferably, the third plug-in portions are arranged at both ends of each plug-in rod, and the third plug-in portions extend from the left and right sides of the side plate.

Preferably, two plug-in rods are arranged on the side plate.

Preferably, the two panels and three side plates form a cavity with an opening facing downward, the bolts pass through the cavity.

Preferably, a gasket is sleeved on each bolt, and each gasket is arranged between the nut and the panel.

The armrest box is assembled by using the assembly method of the armrest box.

A seat, comprising a chair frame and a chair back, a chair seat and a leg rest mounted on the chair frame, the seat further comprises armrest boxes as claimed in claim, and two armrest boxes are respectively mounted on left and right sides of the chair frame.

### 4. BRIEF DESCRIPTION OF ACCOMPANYING DRAWINGS

FIG. 1 is a schematic diagram of the structure of the seat;

FIG. 2 is an exploded view of FIG. 1;

FIG. 3 is a schematic diagram of the connection structure of the seat and the remote control;

FIG. 4 is a schematic diagram of the connection structure of the armrest boxes and the seat;

FIG. 5 is a schematic diagram of the structure of the armrest box;

FIG. 6 is a schematic diagram of the structures of the armrest box frame, the outer cover and the sleeve;

FIG. 7 is a schematic diagram of the connection between the outer cover and the armrest box frame;

FIG. 8 is a schematic diagram of the connection between the panel and the side plates;

FIG. 9 is a schematic diagram of the splicing of the armrest box frame;

FIG. 10 is a schematic diagram of the connection between the panels and the bolts;

FIG. 11 is a schematic diagram of the structure of the panel;

FIG. 12 is a schematic diagram of the structure of the side plate.

In the figures: 1 chair back; 2 chair seat; 3 armrest box; 31 panel; 32 embedding hole; 321 first embedding portion; 322 second embedding portion; 323 third embedding portion; 33 through hole; 34 side plate; 35 snap-fit protrusion; 351 first plug-in portion; 352 second plug-in portion; 353 third plug-in portion; 354 plug-in rod; 36 slide rail; 38 outer cover; 39 zipper; 4 leg rest; 5 chair frame; 51 slider; 6 controller; 61 controller connector; 62 buckle; 63 connecting plug; 64 protrusion; 65 adapter head; 66 power adapter; 67 power plug; 7 bolt; 8 sleeve.

### 5. SPECIFIC EMBODIMENT OF THE INVENTION

The embodiments of the invention are described in detail below, and examples of the embodiments are shown in the accompanying drawings, wherein the same or similar reference numerals throughout represent the same or similar elements or elements having the same or similar functions. The embodiments described below with reference to the accompanying drawings are exemplary and are intended to be used to explain the invention, and should not be construed as limiting the invention.

In the description of the invention, it should be understood that the orientation or positional relationship indicated by the terms “center”, “longitudinal”, “transversal”, “length”, “width”, “thickness”, “upper”, “lower”, “front”, “rear”, “left”, “right”, “vertical”, “horizontal”, “top”, “bottom”, “inner”, “clockwise”, “counterclockwise” and so on are based on the orientation or positional relationship shown in the accompanying drawings, or the orientation or positional relationship that product of the invention is usually placed in when it is used, only for the convenience of describing the invention and simplifying the description, rather than indicating or implying that the indicated device or element must have a specific orientation, as well as a specific orientation structure and operation, therefore, it should not be construed as a limitation of the invention.

In addition, the terms of “first”, “second” and so on are only used to describe the object, and should not be understood as indicating or implying relative importance or implying the number of indicated technical features. Therefore, the features defined with “first” or “second” may expressly or implicitly include one or more of the features, and in the description of the invention, the meaning of “multiple” is two or more, unless otherwise expressly limited.

In the invention, unless otherwise expressly specified and limited, the terms “installation”, “connected”, “connection”, “fixed” and so on should be understood in a broad sense, for example, it may be a fixed connection or a detachable connection or integral connection; it can be a mechanical connection or an electrical connection; it can be a direct connection or an indirect connection through an intermediate medium, and it can be the internal connection between the two components. For those skilled in the art, the specific meanings of the above terms in the invention can be understood according to specific situations.

In the invention, unless otherwise expressly specified and limited, a first feature “on” or “under” a second feature may include direct contact between the first and second feature, or may include contact between the first and second feature not directly but through the other feature between them. Moreover, the first feature “on”, “over” and “above” the second feature include the first feature directly above and obliquely above the second feature, or simply means that the level of the first feature is higher than the level of the second feature. The first feature “under”, “below” and “underneath” the second feature include the first feature directly below and obliquely below the second feature, or simply means that the level of the first feature is lower than the level of the second feature.

### Embodiment

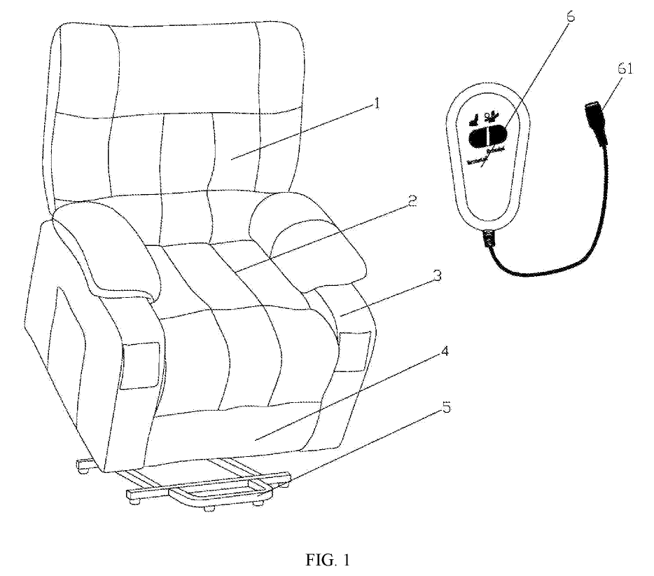

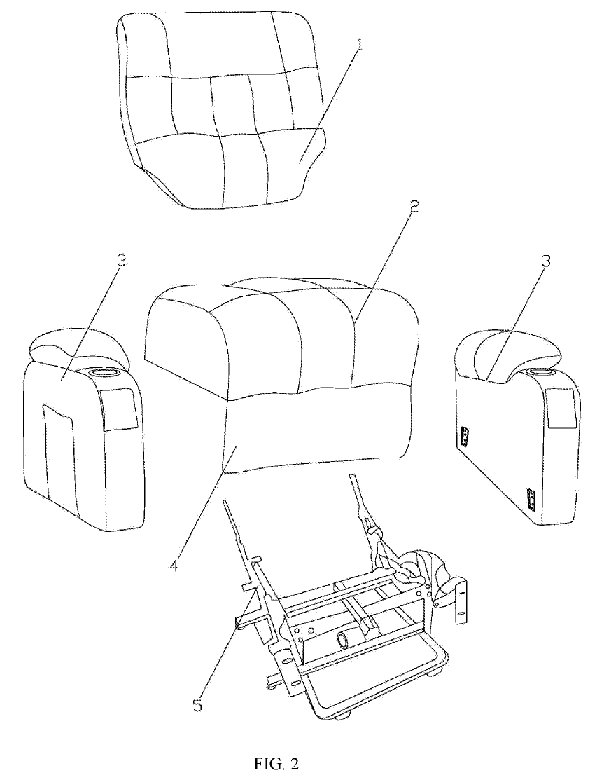

As shown in FIGS. 1-4, a seat, comprising a chair back 1, a chair seat 2, armrest boxes 3, a leg rest 4 and a chair frame 5; two armrest boxes 3 are respectively mounted on left and right sides of the chair frame 5, the leg rest 4 is installed at a front end of the chair frame 5, and the chair back 1 is installed on a rear side of the chair frame 5. The chair frame 5 is configured to control the forward and backward tilt of the chair back 1, and the chair frame 5 is also configured to control the raising of the leg rest 4.

In this embodiment, the specific structure of the chair frame 5 can refer to existing technical documents such as CN108158778A, CN108158778B, and CN112932127A.

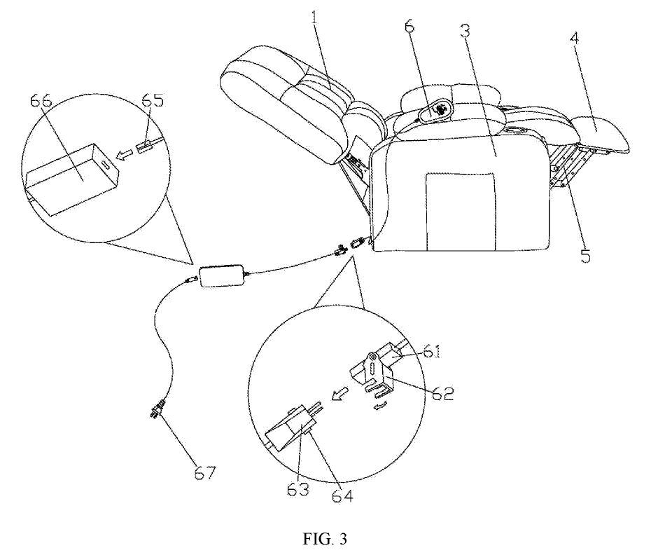

As shown in FIGS. 1 and 3, the seat also includes a controller 6 used to control the movement of the chair frame 5, a controller connector 61 and a connecting plug 63 of a power adapter 66 are detachably connected through a buckle 62, a power cord is provided with a power plug 67 at one end and an adapter head 65 at the other end, the adapter head 65 is plugged into the power adapter 66. As shown in FIG. 3, the connecting plug 63 is provided with two protrusions 64. After the controller connector 61 is plugged into the connecting plug 63, it is hinged and rotates, causing the protrusions 64 on the connecting plug 63 to hook onto the controller connector 61, thus fixing the controller connector 61 and the connecting plug 63 together.

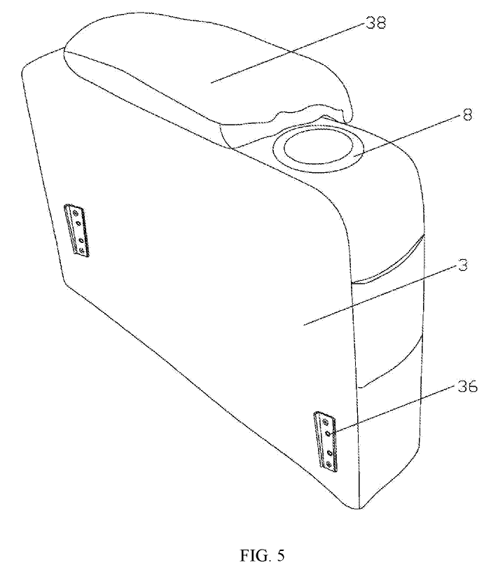

As shown in FIGS. 5-12, an armrest box is applied to the seat.

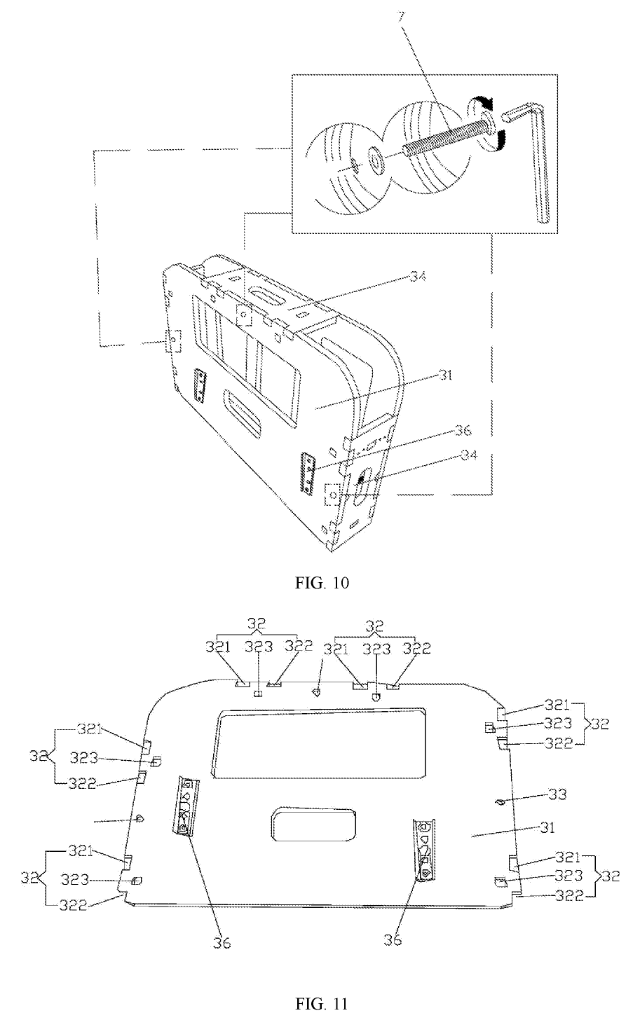

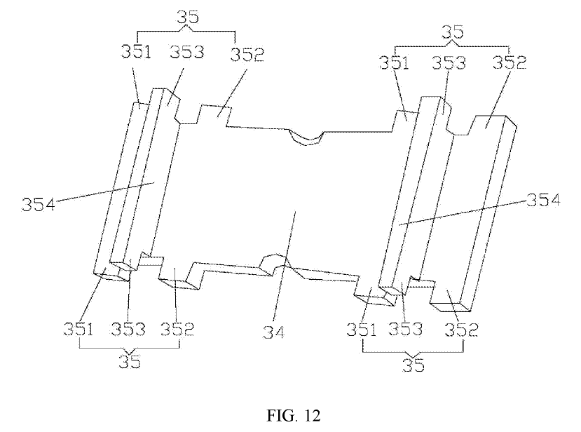

In this embodiment, as shown in FIG. 9, the armrest box 3 comprises two panels 31, three side plates 34; as shown in FIG. 11, top, front, and rear parts of each panel 31 are each provided with two sets of embedding holes 32; as shown in FIG. 12, left and right ends of each side plate 34 are provided with two sets of snap-fit protrusions 35; as shown in FIG. 7 and 10, two panels 31 are arranged on the left and right sides, and the side plates 34 are located between the two panels 31; wherein, one side plate 34 is located between the tops of the two panels 31, one side plate 34 is located between the fronts of the two panels 31, and one side plate 34 is located between the rears of the two panels 31, and the snap-fit protrusions 35 located on the left and right sides of each side plate 34 are respectively inserted into the embedding holes 32 on the two panels 31; as shown in FIG. 10, the two panels 31 are fixedly connected by fasteners, and the fasteners tighten the two panels 31 so that the two panels 31 clamp the side plates 34.

In this way, the armrest box 3 is formed by splicing a plurality of panels, which facilitates the assembly, transportation, maintenance and replacement of the armrest box 3.

As shown in FIG. 10, in this embodiment, the fasteners include bolts 7 and nuts, each panel 31 are each provided with a through hole 33; a threaded part of each bolt 7 passes through the through holes 33 of the two panels 31, and then a nut is installed on the bolt 7, two panels 31 are located between the nuts and the heads of the bolts 7, tightening the nuts will make the two panels 31 clamp the side plates 34; as shown in FIG. 7 and 10, further preferably, the panels 31 and the side plates 34 form a cavity with an opening facing downward, the bolts 7 pass through the cavity. Three groups of fasteners are respectively arranged at the top, front and rear of the panel 31. Each group of fasteners are located in a middle position of two groups of embedding holes 32 on the same side of the panel 31. A gasket is sleeved on each bolt 7, and each gasket is arranged between the nut and the panel 31. With this setup, the bolts 7 are not directly connected to the side plates 34, but are located on inner sides of the three side plates 34, so that the fasteners tighten the panels 31 through the cavity, which in turn makes the connection between the panels 31 and the side plates 34 more stable, without interfering with the position where the panels 31 are connected to the side plates 34. Three groups of fasteners ensure that each side plate 34 can be clamped by the two panels 31, and the fasteners are positioned at the middle of the side plate 34, thereby ensuring the stability of both ends of each side plate 34, as well as the overall stability of the armrest box 3. The three groups of fasteners are arranged in a triangular formation, further enhancing the stability of the connection between the panels 31 and the side plates 34.

In this embodiment, as shown in FIGS. 11 and 12, each embedding hole 32 on each panel 31 comprises a first embedding portion 321, a second embedding portion 322, and a third embedding portion 323; each snap-fit protrusion 35 on each side plate 34 comprises a first plug-in portion 351, a second plug-in portion 352 and a third plug-in portion 353; the first embedding portions 321, the second embedding portions 322 and the third embedding portions 323 cooperate with the first plug-in portions 351, the second plug-in portions 352 and the third plug-in portions 353, respectively.

With this setup, the panels 31 and side plates 34 have multiple snap-fit points, thereby making the connection between the panels 31 and side plates 34 more stable.

Further preferably, as shown in FIGS. 7-12, each first embedding portion 321, second embedding portion 322, and third embedding portion 323 are arranged in a triangular pattern; each first plug-in portion 351, second plug-in portion 352 and third plug-in portion 353 are arranged in a triangular pattern.

Further preferably, as shown in FIGS. 11-12, each first plug-in portion 351, second plug-in portion 352 are both arranged on one side surface of each side plate 34; each first embedded portion 321 and second embedded portion 322 are both arranged in notches at one end of each panel.

Further preferably, plug-in rods 354 are fixed on each side plate 34, both ends of each plug-in rod 354 are provided with protrusions, and the protrusions on the plug-in rods are third plug-in portions 353, the third plug-in portions 353 extend from the left and right sides of each side plate 34. The two plug-in rods 354 are respectively inserted into the third embedding portions 323 of the two groups of embedding holes 32. Each third plug-in portion 353 is located between each first plug-in portion 351 and each second plug-in portion 352. With this setup, the plug-in rods 354 are serve as part of the insertion, and are also be used as reinforcing ribs, thereby increasing the overall strength of the armrest box 3. Additionally, the plug-in rods 354 combine with the side plates 34 to form a stable triangular support structure.

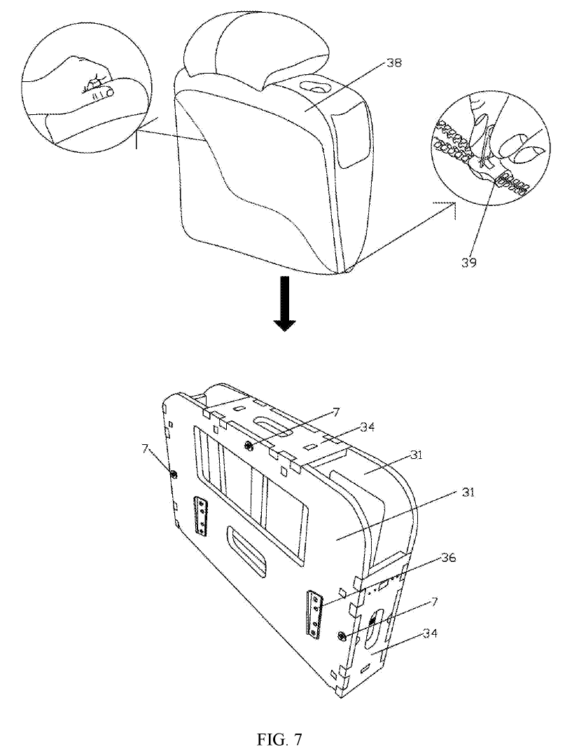

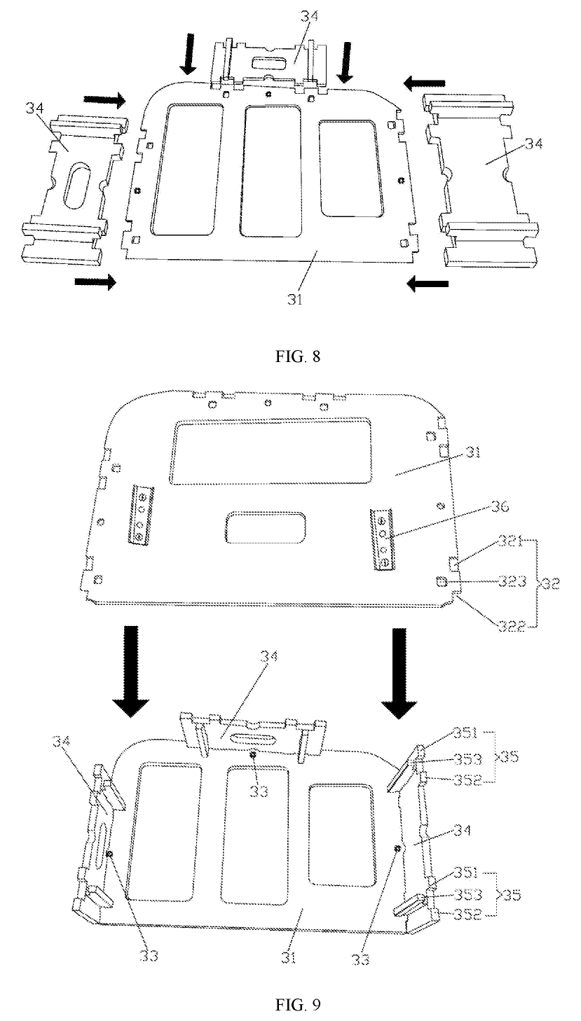

Further preferably, as shown in FIGS. 8 and 9, after each armrest box 3 is assembled, the two ends of the plug-in rods 354 are respectively against the two panels 31.

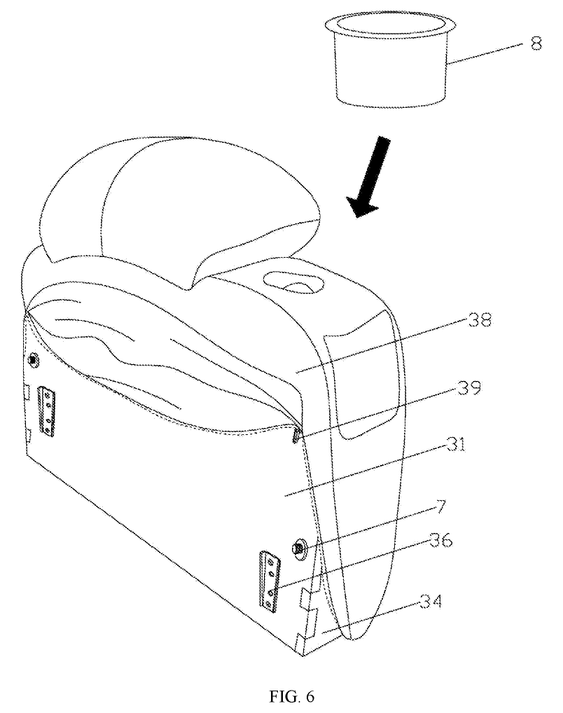

In this embodiment, as shown in FIGS. 5 and 6, a plurality of sides and panels 31 are assembled into an armrest box frame, the armrest box 3 further includes an outer cover 38 that wraps around the armrest box frame, a sleeve is installed on the outer cover 38. The outer cover 38 is an upholstered cover, which has an opening, and the opening is equipped with a zipper. By controlling the zipper 39, the soft cover can be kept in an open or closed state. With this setup, the assembly and disassembly of the armrest box 3 are easier, facilitating the cleaning of the soft cover.

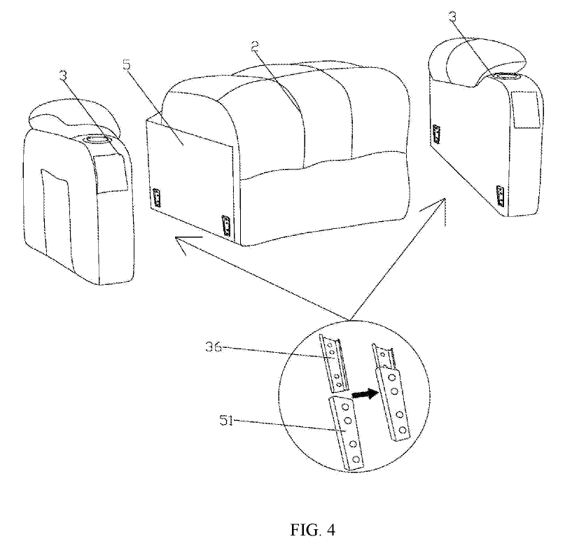

In this embodiment, as shown in FIGS. 4, 5, 6 and 10, slide rails 36 are installed on one panel 31. Two slide rails 36 are arranged front and rear, and the slide rails 36 are exposed from the outer cover 38; left and right ends of the chair frame 5 are each equipped with two front-and-rear arranged sliders; when installing the armrest box 3 onto the chair frame 5, it is only necessary to connect the slide rails 36 and the sliders together. With this setup, the assembly and disassembly of the seat are simplified.

The assembly steps of the armrest box are as follows

step 1: two panels 31 are connected by three side plates 34, the three side plates 34 are respectively arranged between the tops, between the front parts, and between the rear parts of the two panels 31, the snap-fit protrusions 35 on the side plates 34 are inserted into the embedding holes 32 on the panels 31; one side plate is connected only to the top, front, or rear parts of the panels 31; step 2: a threaded part of each bolt 7 passes through the through holes 33 of the two panels 31, and then a nut is installed on the bolt 7, tightening the nut will pull the two panels 31 together, thereby making the two panels 31 clamp the side plates 34; three bolts 7 are installed on the top, front, and rear parts of the panel 31, respectively; step 3: an outer cover 38 is used to enclose the panels 31 and side plates 34.

In the step 1, as shown in FIGS. 8 and 9, the three side plates 34 are first installed on one panel 31, and then the other panel 31 is installed on the three side plates 34.

In the step 3, as shown in FIGS. 6 and 7, after covering the armrest box frame with the outer cover 38, the zipper 39 is pulled to close the outer cover 38.

In the description of the specification, the terms “one embodiment”, “some embodiments”, “example”, “specific example”, or “some examples”, etc., mean the specific features, structures, materials, or characteristics described in connection with the embodiment or example are included in at least one embodiment or example of the invention. In this specification, indicative expressions of the above terms do not necessarily refer to the same embodiment or example. Furthermore, the specific features, structures, materials or characteristics described may be combined in an appropriate manner in any one or more embodiments or examples.

Although the embodiments of the invention have been shown and described above, it should be understood that the above embodiments are exemplary and should not be understood as limitations of the invention. Those skilled in the art can make changes, modifications, substitutions and alterations to the above embodiments within the scope of the invention without departing from the principles and spirit of the invention.

1. An assembly method of an armrest box, comprising panels, side plates, bolts, and nuts;
top, front, and rear parts of each panel are each provided with two sets of embedding holes, and the top, front, and rear parts of each panel are each provided with a through hole; left and right ends of each side plate are provided with two sets of snap-fit protrusions;
the assembly steps of the armrest box are as follows:
step 1: two panels are connected by three side plates, the three side plates are respectively arranged between the tops, between the front parts, and between the rear parts of the two panels, the snap-fit protrusions on the side plates are inserted into the embedding holes on the panels; one side plate is connected only to the top, front, or rear parts of the panels;
step 2: a threaded part of each bolt passes through the through holes of the two panels, and then a nut is installed on the bolt, tightening the nut will pull the two panels together, thereby making the two panels clamp the side plates; three bolts are installed on the top, front, and rear parts of the panel, respectively;
step 3: an outer cover is used to enclose the panels and side plates, completing the assembly.

2. The assembly method of the armrest box of claim 1, wherein in the step 1, the three side plates are first installed on one panel, and then the other panel is installed on the three side plates.

3. The assembly method of the armrest box of claim 1, wherein each embedding hole comprises a first embedding portion, a second embedding portion, and a third embedding portion, each first embedding portion, second embedding portion, and third embedding portion are arranged in a triangular pattern;
each snap-fit protrusion on each side plate comprises a first plug-in portion, a second plug-in portion and a third plug-in portion, the first plug-in portions, the second plug-in portions and the third plug-in portions correspond to the first embedding portions, the second embedding portions and the third embedding portions respectively.

4. The assembly method of the armrest box of claim 3, wherein on each side plate, the first plug-in portions and the second plug-in portions are both arranged on one side surface of the side plate; plug-in rods are fixed on the side plate.

5. The assembly method of the armrest box of claim 4, wherein the third plug-in portions are arranged at both ends of each plug-in rod, and the third plug-in portions extend from the left and right sides of the side plate.

6. The assembly method of the armrest box of claim 4, wherein two plug-in rods are arranged on the side plate.

7. The assembly method of the armrest box of claim 1, wherein the two panels and three side plates form a cavity with an opening facing downward, the bolts pass through the cavity.

8. The assembly method of the armrest box of claim 1, wherein a gasket is sleeved on each bolt, and each gasket is arranged between the nut and the panel.

9. An armrest box, assembled by using the assembly method of the armrest box of claim 1.

10. A seat, comprising a chair frame and a chair back, a chair seat and a leg rest mounted on the chair frame, wherein the seat further comprises armrest boxes as claimed in claim, and two armrest boxes are respectively mounted on left and right sides of the chair frame.
